(19) United States
(12) Patent Application Publication
(10) Pub. No.: US 2026/0223977 A1
(43) Pub. Date: Aug. 6, 2026

(54) AN ARTICLE OF FOOTWEAR, A METHOD FOR MANUFACTURING SAID ARTICLE AND AN APPARATUS USED FOR MANUFACTURING SAID ARTICLE

(71) Applicant: ECCO Sko A/S, Bredebro (DK)

(72) Inventor: Frank Jensen, Bredebro (DK)

(21) Appl. No.: 19/148,590

(22) PCT Filed: Jan. 18, 2024
(86) PCT No.: PCT/DK2024/050006

§ 371 Date: Jul. 16, 2025

(30) Foreign Application Priority Data
Jan. 18, 2023 (DK) PA 2023 70021

(51) Int. Cl. A43B 3/12; A43B 13/04; B29D 35/00

(52) U.S. Cl. CPC A43B 3/122; A43B 13/04; B29D 35/0018

(57) ABSTRACT

An article of footwear includes at least a sole part manufactured of a polymer by molding or casting. The article of footwear further includes at least one strap anchor connected to the sole part via an anchor pillar. The anchor pillar has been manufactured in conjunction with the molding or casting of the sole part.

### FIELD OF THE INVENTION

The invention relates to an article of footwear.

Further, the invention relates to a method for manufacturing a footwear part.

Even further, the invention relates to an apparatus for manufacturing a footwear part, said footwear part comprising at least a sole part.

### BACKGROUND OF THE INVENTION

In connection with manufacturing of footwear of the sandal type, where a sole part is being moulded and thereby attached to e.g. the underside of an insole or footbed, the upper comprising various straps, fasteners, etc. is according to the prior art assembled in advance and attached to e.g. an insole or a footbed, for example by stitching, by cementing or the like. Subsequently, the upper is applied to a last before the last is positioned in relation to a mould, whereafter sole material may be injected in order to complete the sole assembly of the footwear. It will be understood that the manufacturing requires a relatively extensive amount of handling, e.g. requiring assembling and attaching of the upper in advance and applying this to a last, before the moulding process may be performed.

Further, EP 0623293 A1 discloses a sandal comprising a moulded plastic sole on which a moulded plastic midsole is attached. The moulded plastic sole comprises two opposing flaps, which projects upwards from the side edges of the sole. At the top of these flaps an enlarged head has two cuts, one of which is vertical and the other sub-horizontal. Straps, which hold the ankle of a wearer, is threaded into these slots. The manufacture of these sandals require that cuts are made in the flaps, thus requiring additional processing. Further, the flaps are part of the moulded plastic sole and thus have same material properties as the plastic sole.

Even further, US 2009/0217550 A1_discloses a shoe with a multi-component embedded strap, wherein a strap anchor main body with a plurality of projections or arms ending in strap-attachment points is embedded into, and therefore forms part of, the sole of a shoe. The shoe may be manufactured by means of a mould, into which the strap anchor main body is positioned with the strap-attachment points being fixed within a mould cavity. An upper portion of the mould is placed on top of the mould, whereafter moulding material is injected into the mould and cured to form the shoe sole with the strap anchor main body embedded. The moulding material extends over the strap-attachment points and embeds these in the sole. Thus, access to the strap-attachment points are not straight-forward, thereby complicating attachment and/or replacement of straps.

### SUMMARY OF THE INVENTION

In a first aspect, the invention relates to an article of footwear, said article of footwear comprising
at least a sole part being manufactured of a polymer by moulding or casting,
said article of footwear comprising at least one strap anchor,
said at least one strap anchor being connected to said sole part via an anchor pillar, and
said anchor pillar being manufactured in conjunction with the moulding or casting of said sole part.

Hereby, a footwear part may be provided for an article of footwear, wherein one or more strap anchors are utilized such that it will not be necessary in connection with the moulding process to have an upper or at least e.g. straps of an upper, where the upper or straps of the upper has been e.g. stitched to e.g. a footbed, Strobel stitched, cemented to a footbed or in another manner attached to a layer of material that may serve for holding the upper, when it is being applied to a last. Instead, by the invention, the moulding process may be performed in an uncomplicated manner and without use of e.g. a last or the like. After moulding, e.g. by injecting or casting the sole part of a polymer, the sole part will be ready for further manufacturing steps comprising e.g. applying straps of an upper to the readily available strap anchors that are integral parts of the sole part that has been manufactured of a polymer by moulding or casting. Thus, the footwear may thus be provided in a cost-efficient and relatively uncomplicated manner, using a minimum of manual work processes.

Furthermore, as the footwear part comprises one or more strap anchors, replacement of the upper straps can be made by e.g. the user, e.g. in case the user desires to change to another upper design, colour, etc.

It will be understood that by the term anchor pillar will be understood an element connecting the at least one strap anchor to the sole part, which anchor pillar according to the invention is formed in connection with the moulding, e.g. injection or casting of the sole part and thus will be an integral part of the sole.

According to an embodiment, said at least one strap anchor may be a premanufactured element.

Hence, the at least one strap anchor may be selected to have any desirable property as regards e.g. material, strength, wear resistance, colour, appearance, ability to attach to the moulding or casting polymer etc, such that the footwear will fulfil the specific requirements of the manufacturer and/or users.

According to an embodiment, said at least one strap anchor may comprise a material different from the material of the sole part. Thus, it will be understood that the at least one strap anchor may for example be made from any synthetic material, polymers, plastic material, composite materials etc. as well as from any suitable metal materials etc.

According to an embodiment, said at least one strap anchor may be positioned at a level of the article of footwear above said sole part. Hereby, it is achieved that the at least one strap anchor will be easily accessible when installing straps, replacing straps, etc.

According to an embodiment, said anchor pillar being manufactured in conjunction with the moulding or casting of said sole part may comprise the polymer as used for manufacturing said sole part. Hence, it will be understood that the anchor pillar(s) may conveniently be manufactured by use of the moulding or casting material as this e.g. expands or is forced up to reach the strap anchor at the same time as the e.g. sole part is being manufactured.

According to an embodiment, said article of footwear may comprise a footbed.

According to an embodiment, said article of footwear may comprise an outsole, said outsole being a premanufactured part or a part of said sole part being manufactured of a polymer by moulding or casting.

According to an embodiment, said anchor pillar being connected to said at least one strap anchor may be configured for raising said at least one strap anchor to a level above said footbed.

Hereby, a footwear part of the type having one or more strap anchors is provided, whereby the strap anchors are directly connected to the sole part via said anchor pillars, such that the strap anchors are conveniently accessible for e.g. the user, when the e.g. user desires to change a strap or e.g. a more or less complete upper. Further, it will be understood that the raised position provides advantages in connection with manufacture and application of an upper in the manufacturing process.

According to a second aspect, the invention relates to a method of manufacturing a footwear part, said footwear part comprising at least a sole part, said method comprising
providing a mould for said footwear part,
providing a mould closing unit,
providing at least one strap anchor,
releasably placing said at least one strap anchor in a strap anchor fixture,
positioning said mould and said mould closing unit in relative operative positions for forming a mould cavity for moulding said footwear part,
moulding said footwear part by moulding material, whereby part of said moulding material reaches and engages said at least one strap anchor,
opening said mould and removing said at least one strap anchor from said strap anchor fixture, when said moulding material is at least partly cured, whereby a moulded footwear part is provided with said at least one strap anchor attached.

Hereby a footwear part may be manufactured for an article of footwear, wherein one or more strap anchors are utilized, in an efficient manner since the strap anchors may each simply be placed in the strap anchor fixture prior to moulding, in connection with which the moulding material will reach the strap anchors and attach the strap anchors to the moulded footwear part. The moulding or casting material may just contact a part of the strap anchors or may flow around a part of the strap anchors, e.g. a rim part or the like of e.g. a triangular, rectangular, circular or semi-circular bracket or the like. Thereby the operations of the prior art of attaching an upper or straps of an upper to e.g. a footbed, a Strobel or the like can be avoided and a quicker and more cost efficient manufacturing can be achieved.

According to an embodiment, said at least one strap anchor may be a premanufactured element.

Hereby, the at least one strap anchor may be selected to have any desirable property as regards e.g. material, strength, wear resistance, colour, appearance, ability to attach to the moulding or casting polymer etc, such that the footwear will fulfil the specific requirements of the manufacturer and/or users.

According to an embodiment, said at least one strap anchor may comprise a material different from the moulding material of said moulded footwear part.

Thus, it will be understood that the at least one strap anchor may for example be made from any synthetic material, polymers, plastic material, composite materials etc. as well as from any suitable metal materials etc.

According to an embodiment, said at least one strap anchor may be releasably placed in a strap anchor fixture at a level above the footwear part to be moulded.

Hereby, it is achieved that the at least one strap anchor will be easily accessible when installing straps, replacing straps, etc.

According to an embodiment, said at least one strap anchor of said moulded footwear part may be attached to the moulded footwear part via an anchor pillar.

According to an embodiment, said anchor pillar may be manufactured in conjunction with the moulding of said footwear part.

According to an embodiment, said anchor pillar may be manufactured by said moulding material, e.g. the polymer used for the moulding of said footwear part.

Hence, it will be understood that the anchor pillar(s) may conveniently be manufactured by use of the moulding or casting material as this e.g. expands or is forced up to reach the strap anchor at the same time as the e.g. sole part is being manufactured.

According to an embodiment, said mould may be configured with two movable side moulds and a movable bottom mould.

According to an embodiment, said mould for said footwear part may be configured for injection moulding or configured for casting of said footwear part.

According to an embodiment, said strap anchor fixture may be arranged on said mould closing unit or on part of said mould.

According to an embodiment, said strap anchor fixture may be arranged on a side mould, e.g. on a first side mould and/or on a second side mould.

According to an embodiment, said mould closing unit or a side mould of said mould may be configured with a plurality of strap anchor fixtures.

Hereby, strap anchor fixtures for strap anchors arranged along the longitudinal length of the footwear may be arranged such that they will be connected to the sole part that will be moulded, e.g. injected or cast.

According to an embodiment, said at least one strap anchor, e.g. one or more strap anchor fixtures may be arranged on a strap anchor holder unit.

Hereby, the strap anchors may be arranged on the strap anchor holder in an advantageous arrangement, i.e. on a strap anchor holder unit, whereby further it may be easier to switch from one type strap anchors to another, e.g. by switching the strap anchor holder unit.

According to an embodiment, said strap anchor holder unit may be configured to releasably hold a plurality of strap anchors, e.g. 2, 3, 4, 5, 6, etc.

According to an embodiment, said strap anchor holder unit may be configured to be movable in relation to the mould closing unit, e.g. arranged as a hinged, pivotable, slidable or the like anchor strap holder unit.

Hereby, the further operations to be made may be made in an easier manner, e.g. placing a footbed, an insole or the like on the bottom part of the mould closing unit, since the anchor strap holder unit can simply be moved out of the way, thereby making other parts of the mould closing unit or the strap anchor holder more accessible.

According to an embodiment, said mould closing unit and/or said mould may be configured with one or more canals for leading moulding material from said mould cavity to at least a lower part of said at least one strap anchor.

Hereby, an efficient manner of having the moulding material reaching from the mould cavity to the strap anchor is achieved, i.e. via the canal, whereby furthermore the canal may be designed to provide a desired design of a connection from the sole assembly to the strap anchor, i.e. an anchor pillar.

According to an embodiment, said mould closing unit may be configured to hold an insole or a footbed at its bottom part.

According to an embodiment, the method may comprise placing a further sole part such as an outsole within the mould prior to introducing moulding material into said mould cavity.

According to an embodiment, said at least one strap anchor fixture may be configured to releasably hold said at least one strap anchor by a flexible grip, e.g. a click, spring or snap action.

Hereby, the one or more strap anchors may easily, but yet efficiently be placed in the strap anchor fixture, e.g. by simply pushing it into engagement with the strap anchor fixture that may comprise flexible means to hold the strap anchor. The grip provided will be sufficient to ensure that the strap anchors stay in place, e.g. during casting or injection of moulding material.

According to an embodiment, said at least one strap anchor fixture may be configured to release said at least one strap anchor, e.g. when opening said mould, by a mechanical action, e.g. a slight drag.

Hereby, the one or more strap anchors may easily be removed from the strap anchor fixture, e.g. since a relatively minor drag or pull of the now moulded connection from the strap anchor to the moulded sole part will be sufficient to cancel the e.g. flexible grip of the strap anchor fixture.

According to an embodiment, said strap anchor fixture may be configured to release said at least one strap anchor, e.g. when opening said mould, by an automated action.

According to an embodiment, said method may comprise attaching one or more straps to one or more of said at least one strap anchors of said moulded footwear part after release from said mould.

Hereby, the article of footwear, e.g. a sandal, may be brought to the next stage of manufacturing by attaching straps or the like to the one or more strap anchors to form an upper of the article of footwear.

According to an embodiment, in said step of releasably placing said at least one strap anchor in said strap anchor fixture, said at least one strap anchor may be connected to a strap.

Hereby, one or more straps of the footwear upper may be placed on the strap anchor fixture in advance of the moulding, i.e. simultaneous with the placing of the one or more strap anchors on the strap anchor holder. Hereby, the footwear part will be closer to completion when the moulded footwear part is removed from the mould.

In a third aspect, the invention relates to an apparatus for manufacturing a footwear part, said footwear part comprising at least a sole part, said apparatus comprising
a mould and
a mould closing unit,
   wherein a side mould of said mould or said mould closing unit is configured with at least one strap anchor fixture for releasably holding at least one strap anchor, and wherein said side mould and/or said mould closing unit is/are configured with one or more canals for leading moulding material from a mould cavity to at least a lower part of said at least one strap anchor.

By use of such an apparatus, a footwear part may be manufactured for an article of footwear, wherein one or more strap anchors are utilized, in an efficient manner since the strap anchors may each simply be placed in the strap anchor fixture prior to moulding, in connection with which the moulding material will reach the strap anchors and attach the strap anchors to the moulded footwear part. The moulding or casting material may just contact a part of the strap anchors or may flow around a part of the strap anchors, e.g. a rim part or the like of e.g. a triangular, rectangular, circular or semi-circular bracket or the like. Thereby the operations of the prior art of attaching an upper or straps of an upper to e.g. a footbed, a Strobel or the like can be avoided and a quicker and more cost efficient manufacturing can be achieved.

According to an embodiment, said at least one strap anchor fixture may be configured for positioning said at least one strap anchor at a level of the footwear part above said sole part.

Hereby, it can be achieved that the at least one strap anchor of the manufactured article of footwear will be easily accessible when installing straps, replacing straps, etc., since it will be positioned above the sole part, thus being easy to reach.

According to an embodiment, said side mould of said mould or said mould closing unit may be configured with a plurality of strap anchor fixtures to hold a strap anchor each.

According to an embodiment, at least some of said plurality of strap anchor fixtures may be arranged on a strap anchor holder unit.

Hereby, the strap anchors may be arranged on the strap anchor holder in an advantageous arrangement, i.e. on a strap anchor holder unit, whereby further it may be easier to switch from one type strap anchors to another, e.g. by switching the strap anchor holder unit.

According to an embodiment, said strap anchor holder unit may be configured to be movable in relation to the side mould of said mould or said mould closing unit, e.g. arranged as a hinged, pivotable, slidable or the like anchor strap holder unit.

Hereby, the further operations to be made in connection with the foot article manufacturing may be made in an easier manner, e.g. placing a footbed, an insole or the like on the bottom part of the mould closing unit, since the anchor strap holder unit can simply be moved out of the way, thereby making other parts of the mould closing unit and/or the strap anchor holder more accessible.

According to an embodiment, said strap anchor fixture may be configured to releasably hold said at least one strap anchor by a flexible grip, e.g. a click, spring or snap action.

Hereby, the one or more strap anchors may easily, but yet efficiently be placed in/on the strap anchor fixture, e.g. by simply pushing it into engagement with the strap anchor holder that may comprise flexible means to hold the strap anchor. The grip provided will be sufficient to ensure that the strap anchors stay in place, e.g. during casting or injection of moulding material.

According to an embodiment, said strap anchor fixture may be configured to release said at least one strap anchor, e.g. when opening said mould, by a mechanical action, e.g. a slight drag.

Hereby, the one or more strap anchors may easily be removed from the strap anchor fixture, e.g. since a relatively minor drag or pull of the now moulded connection from the strap anchor to the moulded sole part will be sufficient to cancel the e.g. flexible grip of the strap anchor holder.

According to an embodiment, said at least one strap anchor fixture may be configured to release said at least one strap anchor, e.g. when opening said mould, by an automated action.

### THE FIGURES

The invention will be explained in further detail below with reference to the figures of which

FIG. 1 illustrates in a schematic manner an example of a prior art article of footwear,

FIGS. 2a-b illustrate in a schematic manner sideviews of an example of an article of footwear according to an embodiment of the invention,

FIG. 3 illustrates an example of an apparatus comprising a mould for a direct injection process or casting process of a footwear part according to embodiments of the invention,

FIG. 4 illustrates the example of an apparatus comprising a mould for a direct injection process or casting process of a footwear part as shown in FIG. 3, wherein a bottom mould has been moved upwards to define a sole part,

FIG. 5 illustrate a further example of an apparatus comprising a mould for a direct injection process or casting process of a footwear part according to embodiments of the invention, wherein side surfaces of the mould comprise strap anchor fixtures and canals for moulding material,

FIG. 6 shows a further embodiment, wherein a prefabricated outsole is introduced in the mould cavity, and

FIG. 7 corresponds to FIG. 3, wherein it is schematically illustrated that a strap anchor holder unit may be arranged for holding one or more strap anchor fixtures.

### DETAILED DESCRIPTION

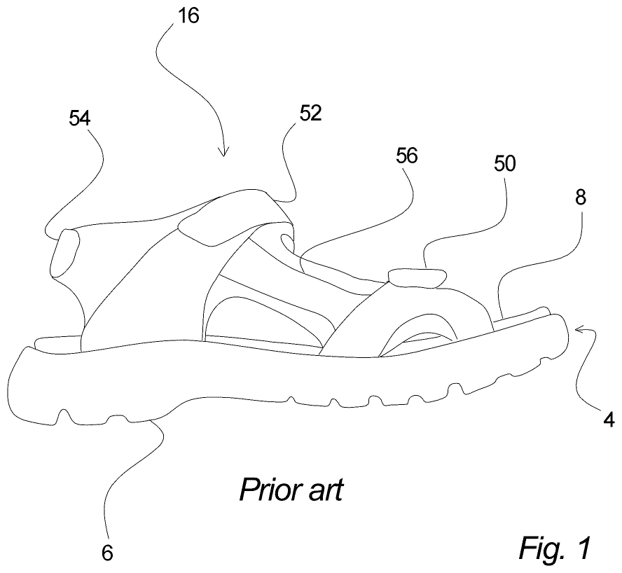

With reference to FIG. 1 an example of an article of footwear according to a prior art will be elucidated. The footwear is a sandal type article of footwear, which comprises a sole assembly 4, an outsole 6, a footbed or insole 8 and an upper 16. The upper 16 is in this example manufactured out of a number of straps, which includes fastening means, adjustable fasteners, etc. as it will be apparent to person skilled within the art. As illustrated, the upper 16 may comprise toe straps 50, heel straps 54, arch straps 52 and cross straps 56, etc. In connection with the manufacture, the upper may have been assembled, e.g. by the straps having been stitched together, cemented together, etc. and the upper 16 has subsequently been e.g. stitched to e.g. a footbed 8, Strobel stitched, cemented to a footbed or in another manner attached to a layer of material that may serve for holding the upper, when it is being applied to a last (not shown in FIG. 1). Subsequent to this, a part or essentially the complete sole assembly 4 may be manufactured by e.g. injection moulding or casting when the lasted upper is positioned in relation to a mould, whereby the sole assembly 4 is being attached to the upper 16.

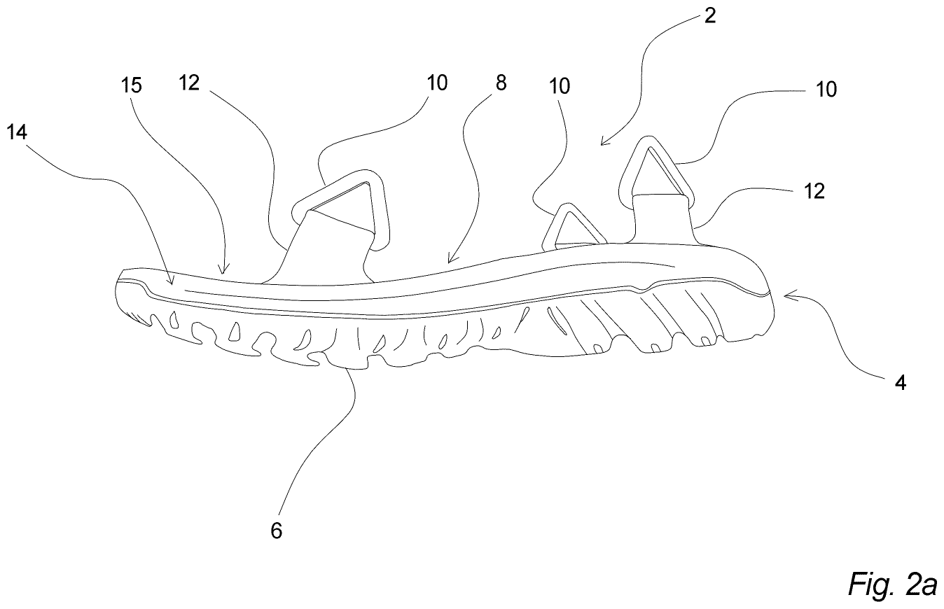

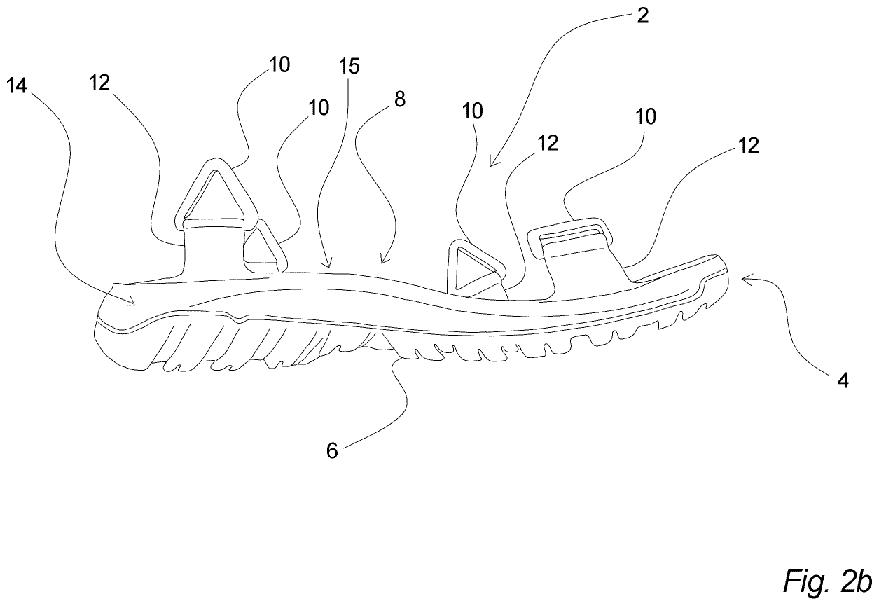

With reference to FIGS. 2a and 2b, an exemplary embodiment of an article of footwear 2 according to the invention is illustrated, where in FIG. 2a the article of footwear is seen in a sideview, showing e.g. the lateral side, and where in FIG. 2b the article of footwear is seen in a sideview, showing e.g. the medial side. The article of footwear is illustrated as a sandal, but it will be understood that a multitude of forms, designs, shapes etc. are possible and that the footwear illustrated is just one of many various embodiments that are feasible according to the invention.

In FIGS. 2a and 2b, an article of footwear 2 is shown, which has not been assembled with a footwear upper, e.g. straps or the like, but wherein a sole assembly 4 is illustrated, which in the present example comprises an outsole 6, which may be prefabricated, e.g. as a rubber outsole with threads as indicated in FIGS. 2a and 2b, and a sole part 14 that as it will be explained below, may be made by injection moulding or casting. Further, the footwear may comprise a footbed 8 or insole. The sole part 14 may for example be a midsole. Also, the foot facing surface 15 of the sole part is indicated in FIGS. 2a and 2b.

The article of footwear 2 furthermore comprises one or more strap anchors 10 which are configured for attaching e.g. straps of an upper to the sole assembly 4 subsequent to injection moulding or casting of the sole part 14. The strap anchor or anchors 10 may be e.g. in the form of e.g. a rim part or the like of e,g, a triangular, rectangular, circular, semi-circular or D-formed bracket, buckles or the like. It will be understood that the strap anchor or anchors 10 may be premanufactured and that they may be separate elements, provided for use in connection with the manufacturing of the footwear article. As it is shown in FIGS. 2a and 2b, these strap anchors 10 are attached to the sole assembly 4, e.g. the sole part 14, via anchor pillars 12 which are integral parts of the sole assembly 4 that has been injection moulded or cast, e.g. by use of a polymer such as PU (Polyurethane) or other suitable polymers. As shown, the strap anchors 10 may in this example be triangular or rectangular, depending on e.g. whether one or two straps are intended to be attached to each of the strap anchors and/or depending on the actual forms of the straps or upper.

It will be understood that the article of footwear 2 as shown in FIGS. 2a and 2b in connection with a further manufacturing step may be assembled with an upper, e.g. upper straps, for example essentially corresponding to a form as shown in connection with the prior art sandal of FIG. 1. Thus, ankle straps, toe straps, heel straps, arch straps and/or cross straps etc. may be connected to the strap anchors of the article of footwear 2 that has been illustrated in FIGS. 2a and 2b without straps. The straps may e.g. be threaded through the anchor straps, and fasteners as normally used within the field such as Velcro fasteners, buckle fasteners, etc may be applied as it will be apparent to a skilled person.

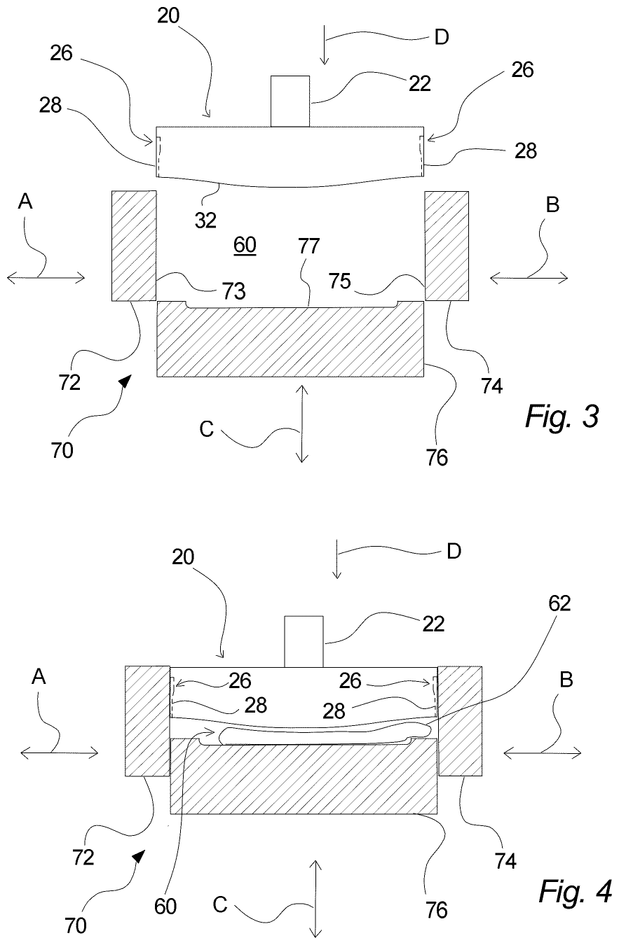

With reference to FIGS. 3 and 4, a method and an apparatus for manufacturing a footwear part, which footwear part comprises at least a sole part, will be explained in the following.

FIG. 3 illustrates a mould 70 for a direct injection or casting process according to embodiments of the invention. Thus, this figure shows schematically a mould 70, seen in a cross-sectional view, which mould 70 may be utilized for direct injection moulding or for casting of e.g. a footwear part that is connected to one or more anchor straps via anchor pillar(s) 14, which are being made at the same time as the footwear part. As it will appear from the following, the cross-sectional view as shown in FIGS. 3 and 4 are taken at a position in the longitudinal direction, which coincides with a position of one anchor strap at each side of the footwear part.

The mould 70 may have been manufactured out of metal, for example aluminum by e.g. CNC machinery and may as shown in FIG. 3 comprise a first side mould 72, a second side mould 74 and a bottom mould 76, which are arranged in such a manner that the mould may be opened and closed e.g. by the first side mould 72 and the second side mould 74 being able to be moved in horizontal directions as indicated with the arrows A, B and by the bottom mould 76 being arranged to be moved in the vertical direction as indicated with the arrow C.

The first side mould 72 and the second side mould 74 may be provided with a first side surface 73 and a second side surface 75, respectively, that have been made during e.g. CNC milling, and which generally define a desired form of a side part of a shoe sole part to be moulded. Further the bottom mould 76 may correspondingly be provided with a bottom inner surface 77, which have been made during the e.g. CNC milling and which generally has a form corresponding to a desired form of the underside of the shoe sole part to be moulded or corresponding to a form of a prefabricated outsole that may be placed in the mould cavity prior to injection or casting.

Further, as shown in FIG. 3, the apparatus for manufacturing a footwear part may comprise a mould closing unit 20, which has an e.g. horizontal shape corresponding to the mould 70 and may be lowered down into the mould 70 as indicated by the arrow D and as illustrated in FIG. 4. As schematically illustrated, this may be effected by a machine fixture 22 that is being handled by e.g. operating machinery.

As further indicated in FIGS. 3 and 4, the mould closing unit 20 has at each side, and possibly at other positions along the length direction of the mould 70 and the mould closing unit 20, indentations which at an upper position define strap anchor fixtures 26, e.g. fixtures which correspond in shape and size to the strap anchors which are desired to be used for the specific footwear part. Further, the fixtures are preferably designed to hold a strap anchor, when it is being positioned, e.g. by friction, snap action, spring action or in any similar fashion, which in the following also may be referred to as “click action” in general. Thus, with the mould closing unit 20 in the position shown in FIG. 3, where it is above the mould 70, it will be seen that the strap anchors may easily be positioned in the strap anchor fixtures 26, e.g. manually or in a more or less automated manner, e.g. using for example a robotic handler.

As also shown in FIGS. 3 and 4, the indentations comprise below the strap anchor fixtures 26 canals 28 for moulding material, which extend to the lower part of the mould closing unit 20 and which serve for leading moulding material from the mould cavity 60 to the respective strap anchors. It is noted that the canals 28 are configured to provide a suitable form and design of anchor pillars, for example having a width corresponding to the dimension of the strap anchors that it is intended to connect to the sole part via the anchor pillars.

It is noted that at the bottom part 32 of the mould closing unit 20 a footbed, an insole or another piece of material may be applied, which during moulding may be attached to the injection or casting material.

Also, it is noted that as shown in FIGS. 3 and 4, the strap anchor fixtures 26 are arranged at such a level that a strap anchor 10 held by a fixture 26 will be at a level above the sole part, e.g. above a foot facing surface 15 (cf. e.g. FIGS. 2a and 2b) of a sole part that is being manufactured.

As further shown in FIG. 4, the bottom mould 76 may be moved upwards to define the thickness of the sole part that is to be moulded in the mould cavity 60 and subsequently injected or casted material 62 may be introduced, e.g. injected or brought into the mould cavity 60. The injected material 62 will expand to fill the mould cavity 60 and furthermore be moved into the canals 28 for moulding material and up to the strap anchor that has been placed in each of the strap anchor fixtures 26. Here, the moulding material will engage, adhere to and possibly extend around at least a lower part of the strap anchor in order to effect a reliable and solid connection upon curing. When the injected or cast material has cured, at least to a sufficient degree, the mould 70 may be opened and the strap anchors which now are connected to the sole part via anchor pillars that have been manufactured, may be removed from the strap anchor fixtures, thus resulting in a footwear part as illustrated in FIGS. 2a and 2b, where the strap anchors 10 are connected to the sole assembly 4, i.e. the moulded sole part 14, by the anchor pillars 12. It is noted that possibly, the strap anchors may be removed from the fixtures, when the mould 70 is opened, simply by a small drag, e.g. caused by the mould closing unit being pulled upwards.

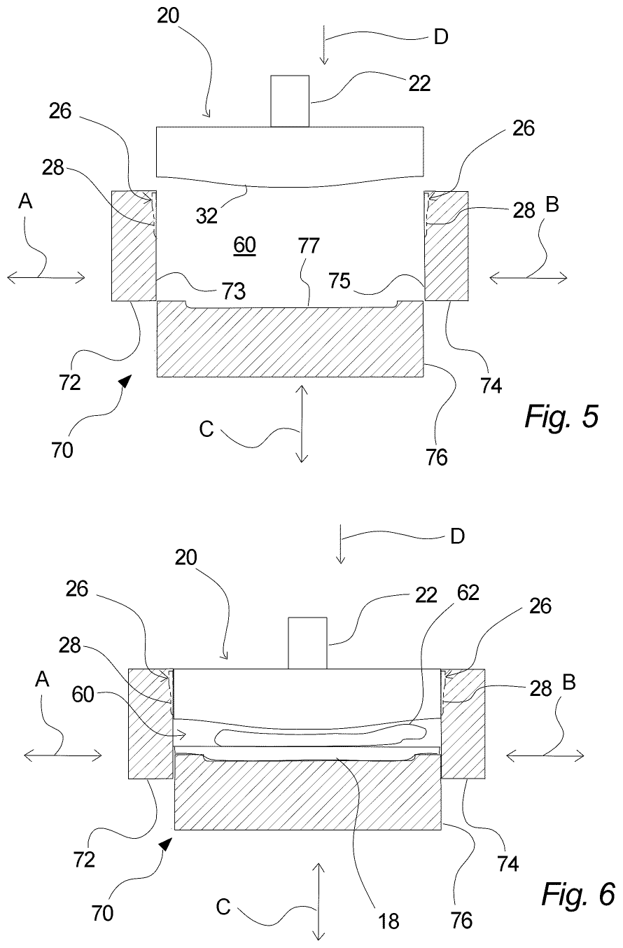

In FIG. 5 a further embodiment is illustrated, also showing schematically a mould 70, seen in a cross-sectional view, which mould 70 may be utilized for direct injection moulding or for casting of e.g. a footwear part that is connected to one or more anchor straps which connections, e.g. anchor pillars, are being made at the same time as the footwear part. However, here it is illustrated that the strap anchor fixtures 26 and the canals 28 for moulding material may be comprised in the first side surface 73 of the first side mould 72 and in the second side surface 75 of the second side mould 74. It will be understood that a similar moulding of anchor pillars to connect the moulded sole part to the respective strap anchors can be effected with this embodiment in a manner similar to the embodiment that was explained above in connection with FIGS. 3 and 4.

It is noted that in connection with the embodiment of FIG. 5, the strap anchor fixtures 26 will be positioned such that the strap anchors 10 of the manufactured footwear are arranged at a level above the sole part, e.g. above a foot facing surface 15 of a sole part that is being manufactured, thus making the strap anchors easily accessible, when positioning or replacing straps of the footwear upper.

Further, it will be understood that the embodiment shown in FIG. 5 may be used as an alternative to the embodiment shown in FIGS. 3 and 4. Furthermore, it is noted that these embodiments may complement each other, e.g. by strap anchor fixtures 26 and canals 28 being arranged at the side moulds 72, 74 as well as at the mould closing unit 20, in case it is found expedient.

In an alternative embodiment as illustrated in FIG. 6, a pre-made outsole 18 has been introduced into the mould cavity 60 prior to the mould 70 being closed. Subsequent to this, the bottom mould 76 may be moved upwards to define the thickness of the combination of the outsole and the sole part 14 that is to be moulded in the mould cavity 60. Thereafter, injected or casted material 62 may be introduced, e.g. injected into the mould cavity 60 on top of the outsole 6. The injected or casted material 62 will expand to fill the mould cavity 60 and furthermore be moved into the canals 28 for moulding material and move up to the strap anchor(s) that has/have been placed in each of the strap anchor fixtures 26. Here, the moulding material will engage, adhere to and possibly extend around at least a lower part of the strap anchor in order to effect a reliable and solid connection upon curing as explained above in connection with FIG. 4. Further, the moulding material adheres to the outsole 6, e.g. the pre-made outsole 18, and a possible footbed 8 or the like, which may be carried by the mould closing unit 20. When the injected material has cured, the mould 70 may be opened.

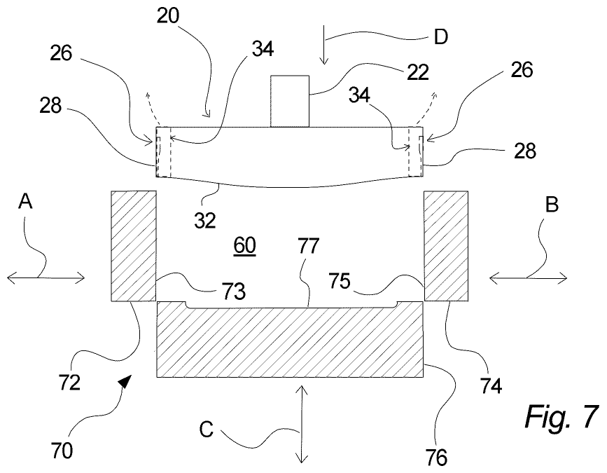

Further, FIG. 7 shows an example of an apparatus comprising a mould for a direct injection process or casting process of a footwear part corresponding to FIG. 3, but wherein it is schematically illustrated with dash lines that one or more strap anchor fixtures 26 and the corresponding canals 28 may be arranged on a strap anchor holder unit 34 on the mould closing unit 20. As indicated with dash arrows, the strap anchor holder unit 34 may be configured to be movable in relation to the mould closing unit 20, e.g. arranged as a hinged, pivotable, slidable or the like anchor strap holder unit. Hereby, the further operations to be made in connection with the foot article manufacturing may be made in an easier manner, e.g. placing a footbed, an insole or the like on the bottom part 32 of mould closing unit 20, since the anchor strap holder unit 34 can simply be moved out of the way, thereby making other parts of e.g. the mould closing unit 20 more accessible.

Furthermore, it may be easier to switch from one type strap anchors to another, e.g. by switching the strap anchor holder unit 34.

Instead of being arranged at the mould closing unit 20, such a movable strap anchor holder unit 34 may be arranged at one or both sides 72, 74 of the mould 70.

In the above description, various embodiments of the invention have been described with reference to the drawings, but it is apparent for a person skilled within the art that the invention can be carried out in an infinite number of ways, using e.g. the examples disclosed in the description in various combinations, and within a wide range of variations within the scope of the appended claims.

### LIST OF REFERENCE

2 Article of footwear
4 Sole assembly
6 Outsole
8 Footbed
10 Strap anchor
12 Anchor pillar
14 Sole part
15 Foot facing surface
16 Upper
18 Pre-made outsole
20 Mould closing unit
22 Machine fixture
26 Strap anchor fixture
28 Canal for moulding material
32 Bottom part
34 Strap anchor holder unit
50 Toe strap
52 Heel strap
54 Arch strap
56 Cross strap
60 Mould cavity
62 Injected or casted material
70 Mould
72 First side mould
73 First side surface
74 Second side mould
75 Second side surface
76 Bottom mould
77 Bottom inner surface

1.-39. (canceled)

40. An article of footwear comprising:
a sole part manufactured of a polymer by molding or casting; and
at least one strap anchor connected to the sole part via an anchor pillar,
wherein the anchor pillar is manufactured in conjunction with the molding or casting of the sole part.

41. The article of footwear according to claim 40, wherein the at least one strap anchor includes a material different from the polymer of the sole part.

42. The article of footwear according to claim 40, wherein the at least one strap anchor is positioned at a level of the article of footwear above the sole part.

43. The article of footwear according to claim 40, wherein the anchor pillar includes the polymer used for manufacturing the sole part.

44. A method of manufacturing a footwear part including a sole part, the method comprising:
providing a mold for the footwear part;
providing a mold closing unit;
providing at least one strap anchor;
releasably placing the at least one strap anchor in a strap anchor fixture;
positioning the mold and the mold closing unit in relative operative positions for forming a mold cavity for molding the footwear part;
molding the footwear part by molding material, whereby part of the molding material reaches and engages the at least one strap anchor; and
opening the mold and removing the at least one strap anchor from the strap anchor fixture, when the molding material is at least partly cured, whereby a molded footwear part is provided with the at least one strap anchor attached.

45. The method according to claim 44, wherein the at least one strap anchor is releasably placed in a strap anchor fixture at a level above the footwear part to be molded.

46. The method according to claim 44, wherein the least one strap anchor of the molded footwear part is attached to the molded footwear part via an anchor pillar.

47. The method according to claim 44, wherein the strap anchor fixture is arranged on the mold closing unit or on part of the mold.

48. The method according to claim 44, wherein the mold closing unit or a side mold of the mold is configured with a plurality of strap anchor fixtures.

49. The method according to claim 44, wherein the at least one strap anchor is arranged on a strap anchor holder unit.

50. The method according to claim 49, wherein the strap anchor holder unit is configured to releasably hold a plurality of strap anchors.

51. The method according to claim 49, wherein the strap anchor holder unit is configured to be a movable in relation to the mold closing unit.

52. The method according to claim 44, wherein the mold closing unit or the mold is configured with one or more canals for leading molding material from the mold cavity to at least a lower part of the at least one strap anchor.

53. The method according to claim 44, wherein the strap anchor fixture is configured to releasably hold the at least one strap anchor by a flexible grip.

54. The method according to claim 44, wherein the strap anchor fixture is configured to release the at least one strap anchor by a mechanical action or by an automated action.

55. An apparatus for manufacturing a footwear part including a sole part, the apparatus comprising:
a mold; and
a mold closing unit,
wherein a side mold of the mold or the mold closing unit is configured with:
at least one strap anchor fixture for releasably holding at least one strap anchor, and
one or more canals for leading molding material from a mold cavity to at least a lower part of the at least one strap anchor.

56. The apparatus according to claim 55, wherein the side mold of the mold or the mold closing unit is configured with a plurality of strap anchor fixtures to hold a strap anchor each.

57. The apparatus according to claim 56, wherein at least some of the plurality of strap anchor fixtures is/are arranged on a strap anchor holder unit.

58. The apparatus according to claim 57, wherein the strap anchor holder unit is configured to be movable in relation to the side mold of the mold or the mold closing unit (20).

59. The apparatus according to claim 55, wherein the at least one strap anchor fixture is configured to releasably hold the at least one strap anchor by a flexible grip.
